(19) United States
(12) Patent Application Publication
(10) Pub. No.: US 2009/0052035 A1
(43) Pub. Date: Feb. 26, 2009

(54) LENS BARRIER MECHANISM

(75) Inventor: Takahiko Morozumi, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/130,473

(22) Filed: May 30, 2008

(30) Foreign Application Priority Data
Aug. 23, 2007 (JP) 2007-217002

(51) Int. Cl. G02B 23/16

(52) U.S. Cl. 359/511

(57) ABSTRACT

According to one embodiment, a lens barrier mechanism includes four barrier blades for opening/closing an opening for a lens. The driving force of a gear arm is transmitted, via a torsion spring, to a ring cam for opening/closing the barrier blades. The torsion spring includes a coil wound on the rotary shaft of the gear arm, and two arms extending from the opposite ends of the coil and engaged with the boss of the ring cam.

### CROSS-REFERENCE TO RELATED APPLICATIONS

This application is based upon and claims the benefit of priority from Japanese Patent Application No. 2007-217002, filed Aug. 23, 2007, the entire contents of which are incorporated herein by reference.

### BACKGROUND

1. Field

One embodiment of the invention relates to a lens barrier mechanism for protecting a lens incorporated in a digital camera or a video movie camera.

2. Description of the Related Art

A lens barrier mechanism is known in which the bosses of barrier blades are fitted in grooves formed in cam members that are attached to a driving ring with a plurality of torsion springs interposed therebetween (see, for example, Jpn. Pat. Appln. KOKAI Publication No. 8-220595). In the lens barrier mechanism, even when the barrier blades are held by the hand of a user during their opening/closing operation, the torsion springs interposed between the driving ring and cam members serve as buffer members for protecting the components from damage.

However, the lens barrier mechanism requires two cam members corresponding to two barrier blades, and requires two torsion springs for each of the two cam members, i.e., four torsion springs in total. Thus, a large number of components are needed, which inevitably increases the device cost and the possibility of failure.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view illustrating a lens barrier mechanism according to an embodiment of the invention, viewed from the front;

FIG. 2 is a perspective view of the lens barrier mechanism of FIG. 1, illustrating a state in which the barrier blades are open;

FIG. 3 is a perspective view illustrating the lens barrier mechanism of FIG. 2, viewed from the rear;

FIG. 4 is an exploded perspective view illustrating the lens barrier mechanism of FIG. 1;

FIG. 5A is a side view illustrating a structure obtained by removing a motor holder from of FIG. 3;

FIG. 5B is a rear view of the structure of FIG. 5A;

FIG. 6 is a rear view illustrating a structure obtained by further removing a motor from FIG. 5B;

FIG. 7 is a rear view as viewed from the side indicated by arrow VII in FIG. 4;

FIG. 8 is a rear view illustrating a state in which the barrier blades shown in FIG. 7 are opened;

FIG. 9 is a view illustrating a state in which no force is exerted on a torsion spring;

FIG. 10 is a view useful in explaining displacement of the torsion spring that occurs when the barrier blades are stopped during their opening;

FIG. 11 is a view useful in explaining displacement of the torsion spring that occurs when the barrier blades are stopped during their closing; and

FIG. 12 is a view illustrating a modification of the embodiment in which the torsion spring is attached in an opposite way.

### DETAILED DESCRIPTION

One embodiment and its modification according to the invention will be described with reference to the accompanying drawings. In general, according to one embodiment of the invention, a lens barrier mechanism comprises barrier blades which open and close an opening; a driving ring which operates the barrier blades; a cam mechanism which uses rotation of the driving ring to open/close the barrier blades; a driving mechanism which rotates the driving ring; and a buffer mechanism which flexibly transmits a driving force of the driving mechanism to the driving ring. Since in the embodiment, the driving force of the driving mechanism is flexibly transmitted to the driving ring, it is not necessary to provide a buffer mechanism between the driving ring and the barrier blades, resulting in simplification of the structure. Accordingly, the lens barrier mechanism can be produced at low cost, and the occurrence of failure can be minimized.

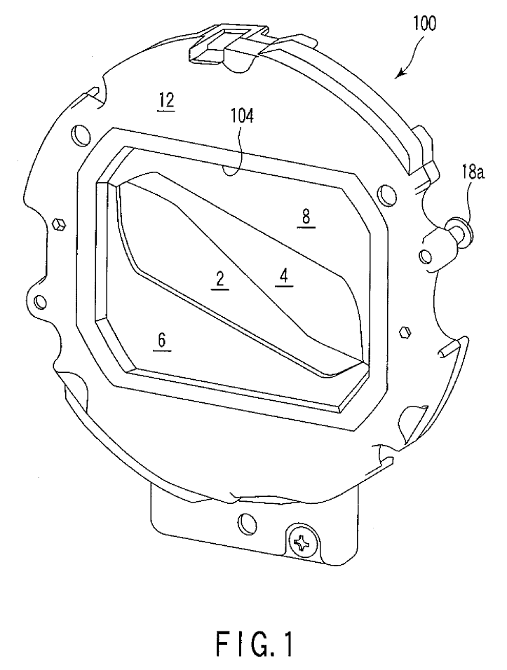

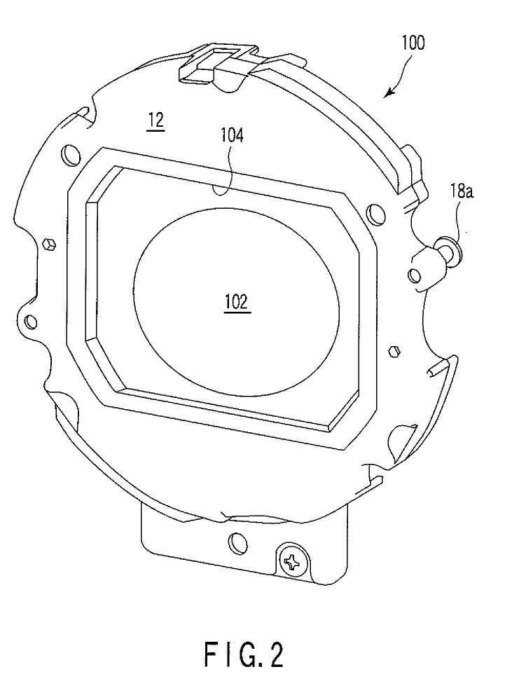

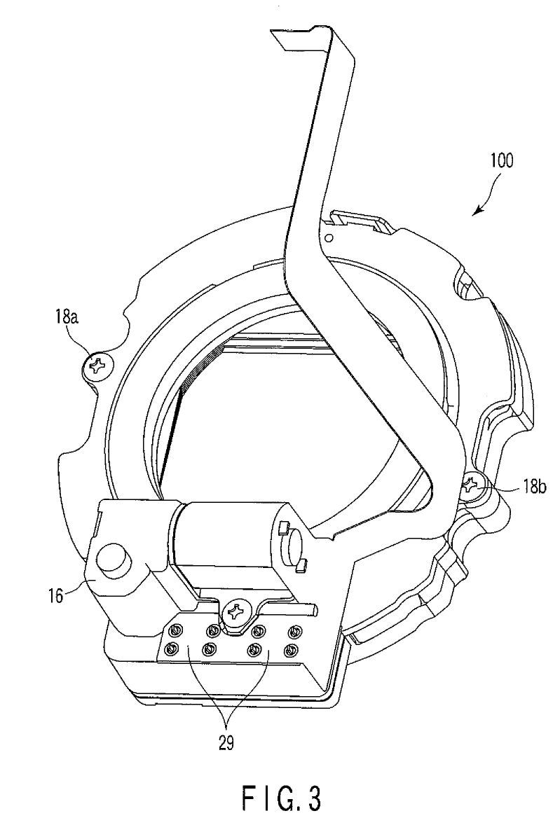

FIGS. 1 and 2 are perspective views illustrating a lens barrier mechanism 100 according to the embodiment of the invention, viewed from the front. The lens barrier mechanism 100 is attached to the front end of the lens barrel (not shown) of, for example, a video movie camera to protect the lens of the camera. In the lens barrier mechanism 100, barrier blades 2, 4, 6 and 8 (described later) are retracted during photography to the open position shown in FIG. 2, and are extended during non-photography in the closure position shown in FIG. 1 to protect the lens. FIG. 3 is a perspective view illustrating the lens barrier mechanism 100, viewed from the rear when the barrier blades 2, 4, 6 and 8 are open. In the description below, FIGS. 1 to 3 will be referred to when necessary.

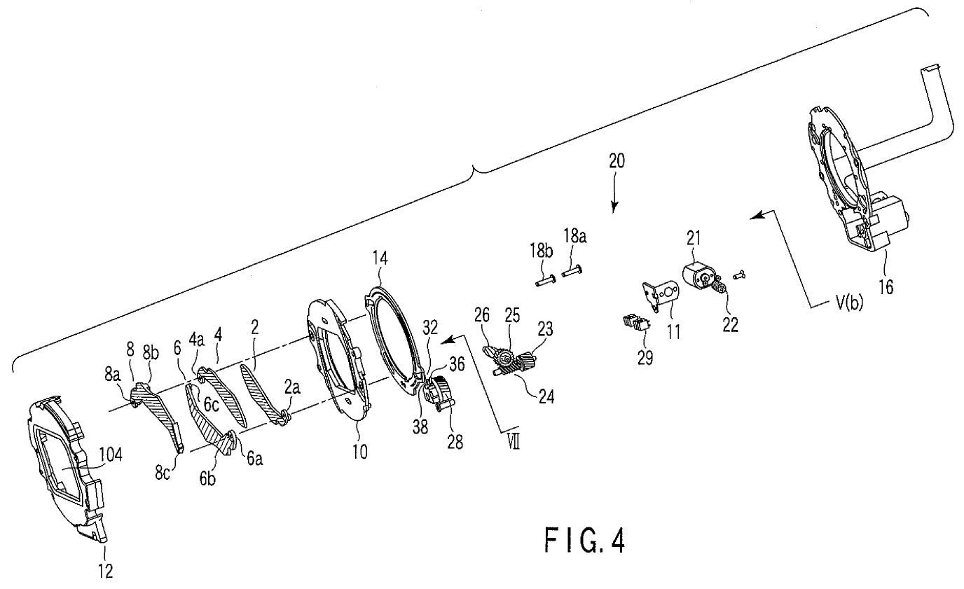

FIG. 4 is an exploded perspective view illustrating the lens barrier mechanism 100. As shown, the lens barrier mechanism 100 comprises four barrier blades 2, 4, 6 and 8, a barrier holder 10, a ring holder 12, a ring cam 14, a driving mechanism 20, and a motor holder 16. The four barrier blades 2, 4, 6 and 8 open and close an opening 104 formed in a lens 102 (see FIG. 2). The barrier holder 10 holds the barrier blades 2, 4, 6 and 8 so that they can rotate about pins (not shown) inserted through rotation axis holes 2a, 4a, 6a and 8a, respectively, to open/close the opening 104. The ring holder 12 is attached to the barrier holder 10 to receive the four barrier blades therebetween. The ring holder 12 serves as the front case member of the lens barrier mechanism 100. The ring cam 14 is provided at the rear side of the barrier holder 10 and serves as a driving ring for opening/closing the four barrier blades 2, 4, 6 and 8. The driving mechanism 20 rotates the ring cam 14 in opposite directions. The driving mechanism 20 will be described in detail later. The motor holder 16 covers the motor 21 of the driving mechanism 20, and serves as the rear case member of the lens barrier mechanism 100. The ring holder 12 and motor holder 16, which serve as the case of the lens barrier mechanism 100, are screwed to each other by two screws 18a and 18b, with the barrier holder 10 interposed therebetween.

The two barrier blades 2 and 6, for example, which are included in the four barrier blades 2, 4, 6 and 8, and provided lower than the other blades in FIG. 1, are attached to the barrier holder 10 so that they overlap each other, with the outside barrier blade 6 positioned closer to the ring holder 12 than the inside barrier blade 2, and so that they can rotate coaxially about pins (not shown) inserted through the rotation axis holes 2a and 6a, respectively.

When the barrier blades close the opening 104, the inside barrier blade 2 and the other inside barrier blade 4 close the central portion of the opening 104, while the outside barrier blade 6 and the other outside barrier blade 8 close the peripheral portion of the opening 104.

The outside barrier blade 6 has a projecting proximal end serving as an engagement portion 6b to be engaged with the outer edge of the inside barrier blade 2, and a projecting distal end 6c. With this structure, when the inside barrier blade 2 is rotated to its closure position, the inner edge of the distal end of the barrier blade 2 is brought into contact with the projecting distal end 6c to thereby rotate the barrier blade 6 to its closure position. In contrast, when the inside barrier blade 2 is rotated to its open position, the engagement portion 6b of the outside barrier blade 6 is engaged with the outer edge of the inside barrier blade 2 to thereby rotate the barrier blade 6 to its open position. Namely, the outside barrier blade 6 is driven to open/close by the opening/closing operations of the inside barrier blade 2.

The other pair of barrier blades 4 and 8 as upper blades in FIG. 1 have the same structures as those of the lower blades 2 and 6, respectively, and operate in the same ways as the blades 2 and 6, respectively. Thus, the outside barrier blade 8 is driven to open/close by the opening/closing operations of the inside barrier blade 4. This being so, in the following description, only the operations of the inside barrier blades 2 and 4 will be described. The overlapping portions of the two inside barrier blades 2 and 4 are slightly tapered to fit on each other so that no clearance is formed therebetween.

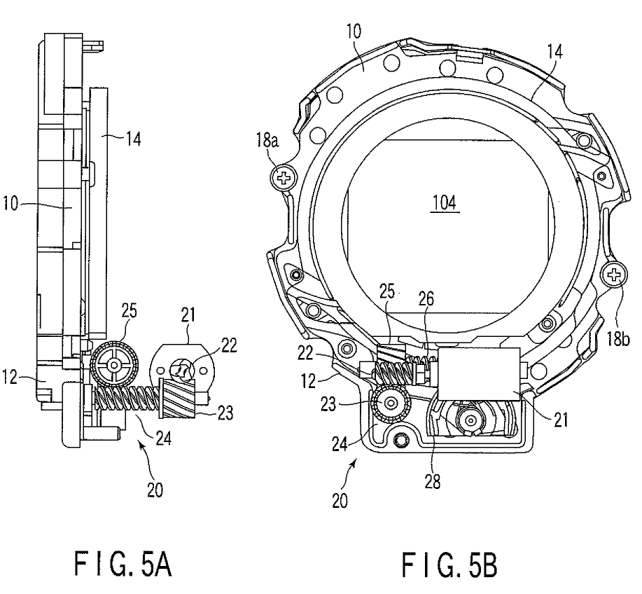

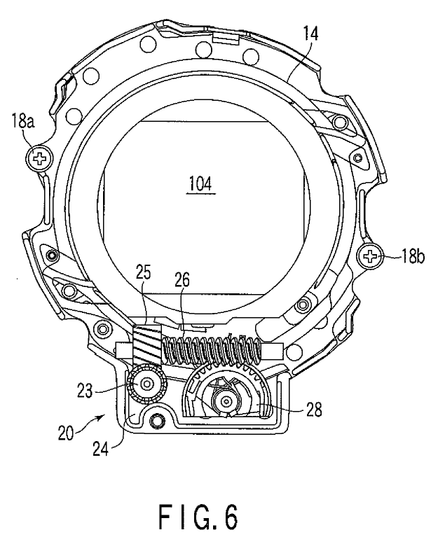

FIG. 5A is a side view illustrating the lens barrier mechanism 100 from which the motor holder 16 is removed. FIG. 5B is a rear view of the lens barrier mechanism 100, as viewed from the side indicated by arrow V(b) in FIG. 4. FIG. 6 is a rear view illustrating the lens barrier mechanism 100 from which the motor 21 and a worm gear 22 are further removed.

As shown in detail in FIGS. 5A, 5B and 6, the driving mechanism 20 of the lens barrier mechanism 100 comprises a worm gear 22 attached to the rotation shaft of the motor 21, a helical gear 23 engaged with the worm gear 22, a worm gear 24 coaxially attached to the helical gear 23, a helical gear 25 engaged with the worm gear 24, a worm gear 26 coaxially attached to the helical gear 25, and a gear arm 28 engaged with the worm gear 26. The rotational driving force of the motor 21 is transmitted to the gear arm 28 via the worm gear 22, helical gear 23, worm gear 24, helical gear 25 and worm gear 26.

The range of swing of the gear arm 28 is limited by detecting the to-be-detected portion (not shown) of the gear arm 28 using photodetectors 29 (see FIGS. 3 and 4). Further, the motor 21 is secured to the motor holder 16 via a motor plate 11 (see FIG. 4).

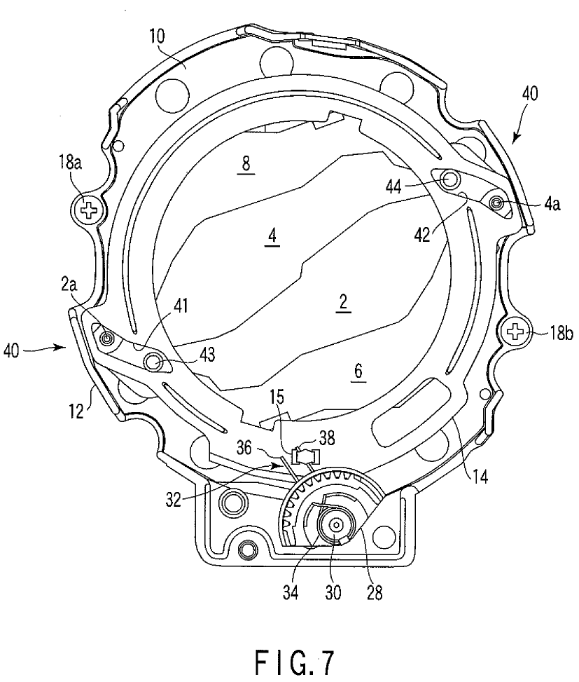

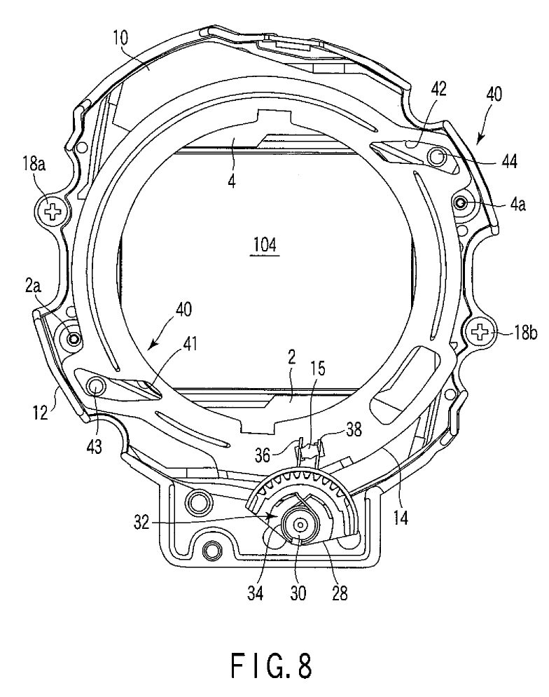

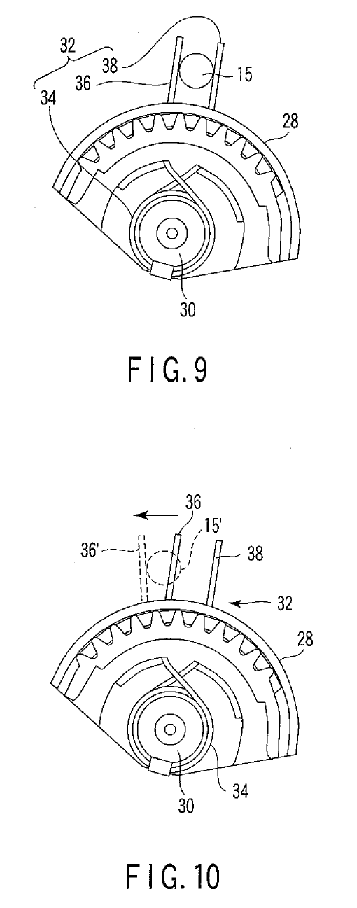

FIG. 7 is a rear view as viewed from the side indicated by arrow VII in FIG. 4. FIG. 8 is a rear view illustrating a state in which the barrier blades 2, 4, 6 and 8 shown in FIG. 7 are opened. As shown in FIGS. 7 and 8, the rotary shaft 30 of the above-mentioned gear arm 28 is wound by the coil 34 of the torsion spring 32. As is clearly shown in the enlarged figure of FIG. 9, the torsion spring 32 is formed by winding a single metal wire, and includes the coil 34 formed by winding the metal wire, and two arms 36 and 38 extending from the opposite ends of the coil 34.

The ring cam 14 for opening/closing the barrier blades 2, 4, 6 and 8 has a projecting boss 15 received between the arms 36 and 38. With this structure, the driving force of the driving mechanism 20 is flexibly transmitted to the gear arm 28, and then to the ring cam 14 via the torsion spring 32. Namely, when the gear arm 28 is rotated by the driving mechanism 20, the torsion spring 32 (i.e., the coil 34) attached to the rotary shaft 30 of the gear arm 28 is swung to thereby swing the two arms 36 and 38. As a result, the boss 15 between the arms 36 and 38, and hence the entire ring cam 14, is moved.

When, for example, the gear arm 28 is clockwise rotated by the driving mechanism 20 from the closure position shown in FIG. 7, the left-hand (in FIG. 7) arm 36 of the torsion spring 32 presses the boss 15 to counterclockwise rotate the ring cam 14 to the open position shown in FIG. 8. At this time, a cam mechanism 40, which is formed of two cam holes 41 and 42 in the ring cam 14 and bosses 43 and 44 projecting near the rotation axis holes 2a and 4a of the two inside barrier blades 2 and 4, operates to use the rotation of the ring cam 14 to open the barrier blades 2 and 4. More specifically, when the ring cam 14 is counterclockwise rotated from the position of FIG. 7, the edge of one cam hole 41 downwardly presses the boss 43 of the inside barrier blade 2, whereby the barrier blade 2 is clockwise rotated about the pin inserted in the rotation axis hole 2a to reach its open position. At the same time, the edge of the other cam hole 42 upwardly presses the boss 44 of the inside barrier blade 4, whereby the barrier blade 4 is clockwise rotated about the pin inserted in the rotation axis hole 4a to reach its open position.

In contrast, when the gear arm 28 is counterclockwise rotated by the driving mechanism 20 from the open position shown in FIG. 8, the right-hand (in FIG. 8) arm 38 of the torsion spring 32 presses the boss 15 to clockwise rotate the ring cam 14 to the closure position shown in FIG. 7. At this time, the cam mechanism 40 operates in the way opposite to the above-mentioned operation to use the rotation of the ring cam 14 to close the barrier blades 2 and 4. More specifically, when the ring cam 14 is clockwise rotated from the position of FIG. 8, the edge of one cam hole 41 upwardly presses the boss 43 of the inside barrier blade 2 to rotate the barrier blade 2 to the closure position shown in FIG. 7. At the same time, the edge of the other cam hole 42 downwardly presses the boss 44 of the inside barrier blade 4 to rotate the barrier blade 4 to the closure position shown in FIG. 7.

As described above, the torsion spring 32 serves as a transmission member for transmitting the driving force of the driving mechanism 20 to the ring cam 14. In addition, the torsion spring 32 also serves as a buffer member when the barrier blades 2, 4, 6 and 8 are stopped during their opening/closing operations. Referring now to FIGS. 9 to 11, a description will be given of the buffer function of the torsion spring 32.

When the barrier blades 2, 4, 6 and 8 operate normally and the torsion spring 32 simply serves as a driving-force transmission member as shown in FIG. 9, the torsion spring 32 transmits the driving force of the driving mechanism 20 to the boss 15 of the ring cam 14, with its shape almost unchanged.

However, if, for example, the barrier blades 2, 4, 6 and 8 are held by the hand of a user while they are rotating from the closure position of FIG. 7 toward the open position of FIG. 8, the ring cam 14 for transmitting the riving force of the driving mechanism 20 to the barrier blades utilizing the cam mechanism 40 is stopped, although the gear arm 28 is kept clockwise rotating by the driving mechanism 20. At this time, as shown in FIG. 10, the left-hand arm 36 of the torsion spring 32 attached to the rotary shaft 30 of the gear arm 28 is displaced (toward the position indicated by the broken line 36′) away from the other arm 38, thereby allowing the boss 15′ of the stopped ring cam 14 to stop, and allowing the gear arm 28 to continue the rotation.

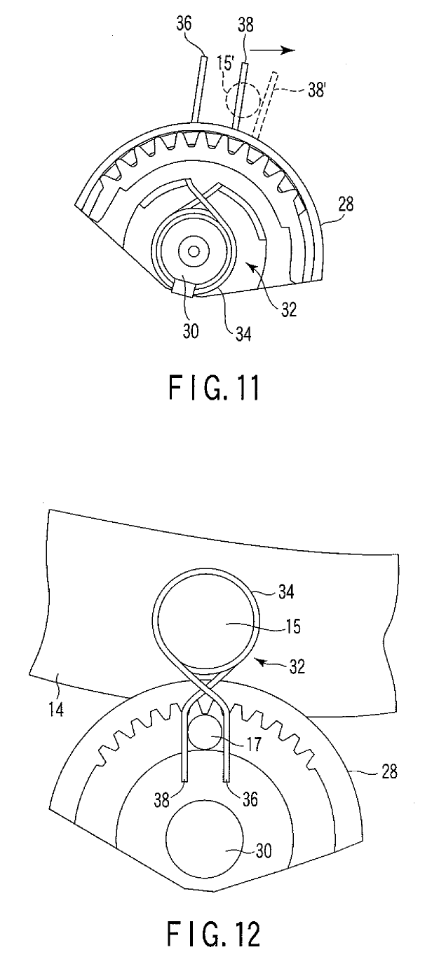

Further, if, for example, the barrier blades 2, 4, 6 and 8 are held by the hand while they are rotating from the open position of FIG. 8 toward the closure position of FIG. 7, the ring cam 14 for transmitting the driving force to the barrier blades utilizing the cam mechanism 40 is stopped, although the gear arm 28 is kept counterclockwise rotating by the driving mechanism 20. At this time, as shown in FIG. 11, the right-hand arm 38 of the torsion spring 32 attached to the rotary shaft 30 of the gear arm 28 is displaced (toward the position indicated by the broken line 38′) away from the other arm 36, thereby allowing the boss 15′ of the stopped ring cam 14 to stop, and allowing the gear arm 28 to continue the rotation.

As described above, in the lens barrier mechanism 100 of the embodiment, the torsion spring 32 is interposed between the driving shaft 30 of the driving mechanism 20 (i.e., the rotary shaft 30 of the gear arm 28) and the boss 15 of the ring cam 14, which are used to drive the barrier blades 2, 4, 6 and 8, to flexibly transmit a driving force therebetween, peripheral components provided around the barrier blades are prevented from being damaged by the stress that occurs in the barrier blades when, for example, the barrier blades are undesirably held by the hand of a user during their opening/closing operation.

Furthermore, since a buffer mechanism formed of only a single torsion spring 32 is provided between the driving mechanism 20 and the ring cam 14, it is not necessary to provide a buffer mechanism, such as a spring, between each barrier blade 2, 4 and the ring cam 14 (driving ring). This enables the entire structure to be simplified, the number of required components to be reduced, and hence the resultant lens barrier mechanism to be produced at low cost. In addition, since only a single torsion spring 32 is used, it is not necessary to balance the urging forces of a plurality of springs as in the prior art, but it is sufficient if the urging force of only one torsion spring 32 is managed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For instance, in the above-described embodiment, the coil 34 of the torsion spring 32 is wound on the driving shaft 30 of the driving mechanism 20 so that the two arms 36 and 38 are engaged with the boss 15 of the ring cam 14. However, the invention is not limited to this, but may be modified such that the coil 34 of the torsion spring 32 is wound on the boss 15 of the ring cam 14, and the two arms 36 and 38 are engaged with the boss 17 of the gear arm 28, as is shown in FIG. 12.

Further, although in the embodiment, the torsion spring 32 is used as the buffer mechanism for transmitting a driving force in a buffered manner, another buffer mechanism, such as a plate spring, may be interposed between the driving shaft 30 and the ring cam 14.

What is claimed is:

1. A lens barrier mechanism comprising:
barrier blades configured to open and close an opening;
a driving ring configured to operate the barrier blades;
a cam mechanism configured to use rotation of the driving ring to open and close the barrier blades;
a driving mechanism configured to rotate the driving ring; and
a buffer mechanism configured to flexibly transmit a driving force of the driving mechanism to the driving ring.

2. The lens barrier mechanism of claim 1, wherein the buffer mechanism is a torsion spring.

3. The lens barrier mechanism of claim 2, wherein the torsion spring comprises a coil wound on a driving shaft of the driving mechanism, and arms extending from opposite ends of the coil and engaged with the driving ring.

4. The lens barrier mechanism of claim 3, wherein the driving ring comprises a boss interposed between the arms of the tension spring.

5. The lens barrier mechanism of claim 2, wherein the torsion spring comprises a coil wound on a driving shaft of the driving mechanism, and arms extending from opposite ends of the coil, the torsion spring transmitting the driving force of the driving mechanism to the driving ring via the arms.
